(19) United States
(12) Patent Application Publication
(10) Pub. No.: US 2024/0270167 A1
(43) Pub. Date: Aug. 15, 2024

(54) DISPLAY DEVICE

(71) Applicant: Panasonic Intellectual Property Management Co., Ltd., Osaka (JP)

(72) Inventors: Takahiro SHUGYO, Kanagawa Ken (JP); Katsuyuki AWAZU, Kanagawa Ken (JP)

(73) Assignee: Panasonic Intellectual Property Management Co., Ltd., Osaka (JP)

(21) Appl. No.: 18/583,465

(22) Filed: Feb. 21, 2024

Related U.S. Application Data
(63) Continuation of application No. PCT/JP2023/040252, filed on Nov. 8, 2023.

(30) Foreign Application Priority Data
Feb. 13, 2023 (JP) 2023-020129

(51) Int. Cl. B60R 1/12; B60R 1/04; B60R 1/08

(52) U.S. Cl. CPC B60R 1/1207; B60R 1/04; B60R 1/08; B60R 2001/1223; B60R 2001/1253

(57) ABSTRACT

A display device includes a transmission reflection member, a display panel, a sensor, an operating mechanism, and a control circuit. The transmission reflection member transmits part of incident light and reflects part of the incident light. The sensor includes a base material, a light emission element, and a light detection element. The light emission element is located on a first surface of the base material. The light detection element is located on the first surface to receive reflected light of emitted light. The control circuit performs control to switch on and off of the display panel on the basis of an amount of received light. The operating mechanism switches a relative position of the sensor with respect to the operating mechanism between a first position and a second position different from the first position to change the amount of light received by the light detection element.

### CROSS-REFERENCE TO RELATED APPLICATIONS

This application is a continuation of International Application No. PCT/JP2023/040252, filed on Nov. 8, 2023, which claims the benefit of priority of the prior Japanese Patent Application No. 2023-020129, filed on Feb. 13, 2023, the entire contents of which are incorporated herein by reference.

### FIELD

The present disclosure relates generally to a display device.

### BACKGROUND

In recent years, in place of a conventional room mirror, a display system that captures a rear image of a vehicle using an imaging device and displays the captured image, and a display device related thereto has been known.

A patent literature JP 2018-527245 A discloses a display device mounted on a vehicle, the display device including: an actuator that switches the display device between a first position and a second position; and a sensor that detects a position of the actuator, in which a mode for displaying image data of the rear of the vehicle and a mode for displaying a mirror image of the rear of the vehicle are switched according to the position of the actuator detected by the sensor.

### SUMMARY

A display device according to an embodiment of the present disclosure includes a transmission reflection member, a display panel, a sensor, an operating mechanism, and a first control circuit. The transmission reflection member is configured to transmit part of incident light and reflect part of the incident light. The display panel is configured to display an image. The sensor includes a base material, a light emission element, and a light detection element. The base material has a first surface. The light emission element is located on the first surface. The light detection element is located on the first surface and receiving reflected light of light emitted by the light emission element. The first control circuit is configured to perform control to switch on and off of the display panel on the basis of an amount of light received by the light detection element. The operating mechanism is configured to switch a relative position of the sensor with respect to the operating mechanism between a first position and a second position different from the first position, and change the amount of light received by the light detection element.

### BRIEF DESCRIPTION OF DRAWINGS

FIG. 1 is a diagram schematically illustrating a display system according to a first embodiment;

FIG. 2 is a perspective view illustrating a structure of a display device according to the first embodiment;

FIG. 3 is a front view illustrating a structure of the display device according to the first embodiment;

FIG. 4 is a cross-sectional view of the display device according to the first embodiment taken along a line A-A in a case where the display device takes a first posture;

FIG. 5 is a cross-sectional view of the display device according to the first embodiment taken along the line A-A in a case where the display device takes a second posture;

FIG. 6 is a front view schematically illustrating a structure of a sensor according to the first embodiment;

FIG. 7 is a perspective view illustrating a positional relationship between the sensor and a protruding part in the case where the display device according to the first embodiment takes the first posture;

FIG. 8 is a cross-sectional view of the display device according to the first embodiment taken along a line B-B in the case where the display device takes the first posture;

FIG. 9 is a cross-sectional view of the display device according to the first embodiment taken along the line B-B in the case where the display device takes the second posture;

FIG. 10 is a cross-sectional view of a display device according to a second embodiment taken along the line A-A in a case where the display device takes the first posture; and

FIG. 11 is a cross-sectional view of the display device according to the second embodiment taken along the line A-A in a case where the display device takes the second posture.

### DETAILED DESCRIPTION

A display device according to the present disclosure is configured as follows.

Hereinafter, the same or equivalent components, members, or steps illustrated in the drawings are denoted by the same reference numerals, and redundant description will be appropriately omitted. In addition, the dimensions of each member in each drawing are appropriately enlarged or reduced in order to facilitate understanding.

### First Embodiment

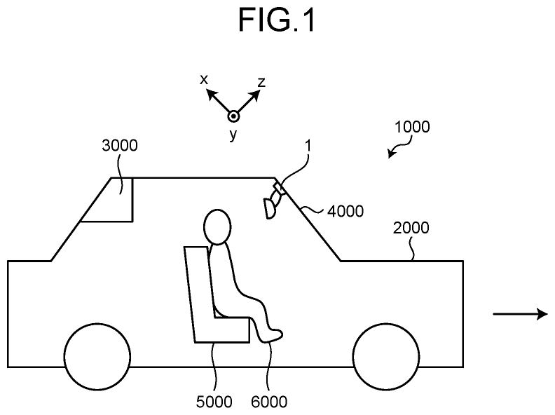

FIG. 1 illustrates an example of a schematic configuration of a display system 1000 in a first embodiment of the present disclosure. In the present embodiment, the display system 1000 is mounted on a vehicle 2000. The display system 1000 includes an imaging device 3000 and a display device 1.

Here, the right side of FIG. 1 corresponds to the front side of the vehicle 2000. In a case where the vehicle 2000 moves forward, the vehicle 2000 travels toward the right side of FIG. 1. The vehicle 2000 includes a windshield 4000 and a seat 5000.

As illustrated in FIG. 1, an orthogonal coordinate system including an x-axis, a y-axis, and a z-axis is defined.

The x-axis extends along the windshield 4000. The x-axis has the same inclination angle as the inclination angle of the windshield 4000. The positive direction of the x-axis is a direction going up toward the rear of the vehicle 2000 along the windshield 4000. The negative direction of the x-axis is a direction going down toward the front of the vehicle 2000 along the windshield 4000.

The y-axis is orthogonal to the x-axis. In addition, the y-axis extends in the left-right direction of the vehicle 2000. Therefore, an x-y plane coincides with a surface of the windshield 4000. The positive direction of the y-axis is a direction toward the right side of the vehicle 2000 in the case where the vehicle 2000 moves forward. The negative direction of the y-axis is a direction toward the left side of the vehicle 2000 in the case where the vehicle 2000 moves forward.

The z-axis is perpendicular to the x-axis and the y-axis. The z-axis extends in the normal direction of the surface of the windshield 4000. The positive direction of the z-axis is a direction in which a normal line on the surface of the windshield 4000 extends toward the front of the vehicle 2000. The negative direction of the z-axis is a direction in which the normal line on the surface of the windshield 4000 extends toward the rear of the vehicle 2000.

In other words, the negative direction of each of the x-axis, the y-axis, and the z-axis is defined in a direction opposite to the positive direction of each of the x-axis, the y-axis, and the z-axis. The positive directions of the x-axis and the z-axis are respectively indicated by arrows in FIG. 1.

Hereinafter, the positive direction of the x-axis may be referred to as “rear” or “rear side”, the negative direction of the x-axis may be referred to as “front” or “front side”, the positive direction of the y-axis may be referred to as “rightward” or “right side”, the negative direction of the y-axis may be referred to as “leftward” or “left side”, the positive direction of the z-axis may be referred to as “upward” or “upper side”, and the negative direction of the z-axis may be referred to as “downward” or “lower side”. Here, the rear and the front with respect to the x-axis are different from the rear and the front with respect to the vehicle 2000, and the upward and the downward with respect to the z-axis are different from the upward and the downward with respect to the vehicle 2000, but these may be used without being clearly distinguished.

Moreover, in the present specification, expressions indicating the posture, position, or the like of one or more objects, such as parallel or center, may be used, but these expressions include a case where these expressions are not strictly the posture, position, or the like. For example, parallel means not only being completely parallel, but also being substantially parallel, namely, including a difference of, for example, about several percent. The same applies to an expression such as perpendicular indicating a relationship between two or more pieces of information or objects.

The imaging device 3000 captures an image of the rear of the vehicle 2000. The imaging device 3000 is mounted on a rear part of the vehicle 2000. The imaging device 3000 outputs the captured image to the display device 1. The vehicle 2000 may include an electronic control unit (ECU) (not illustrated), and the imaging device 3000 may be connected to the display device 1 via the ECU. In other words, the imaging device 3000 may be connected to the display device 1 via a network. Any one of wireless communication, wired communication, and a combination thereof is used for the connection via the network. The imaging device 3000 may be directly connected to the display device 1. Hereinafter, an example in which the vehicle 2000 includes the ECU will be described.

The display device 1 receives an input of an image from the imaging device 3000 and displays the image received from the imaging device 3000. The display device 1 is attached to a position inside the vehicle 2000 where an occupant 6000 can visually recognize an image. The occupant 6000 is seated in the seat 5000. The display device 1 may be installed on the windshield 4000. For example, the display device 1 may be installed at a position near the center of the windshield 4000 in the left-right direction and near the upper end of the windshield 4000 in the up-down direction. In a case where the seat 5000 is a driver's seat, the occupant 6000 corresponds to a driver.

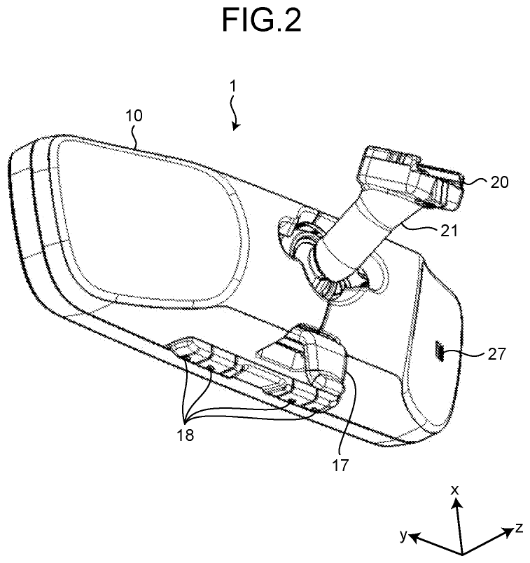

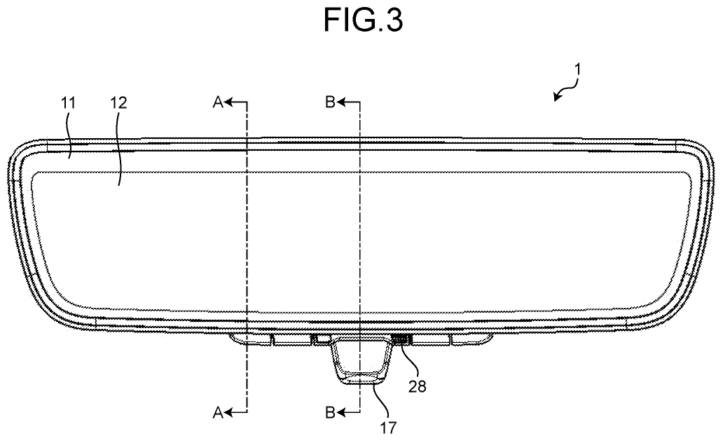

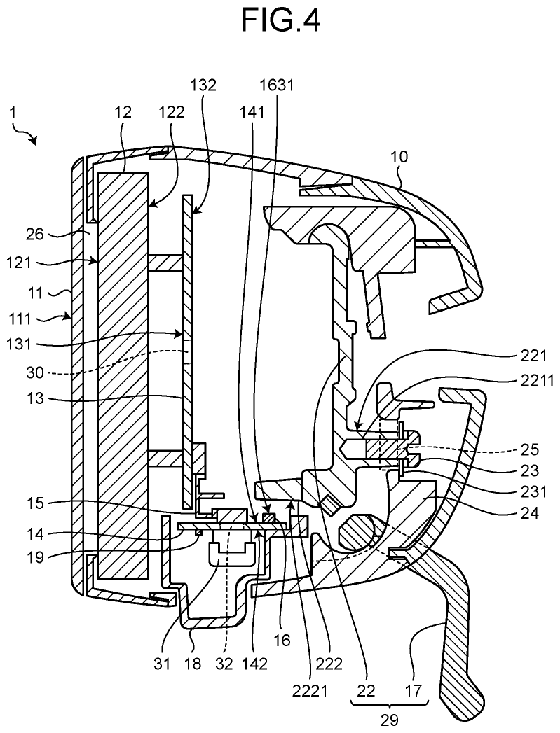

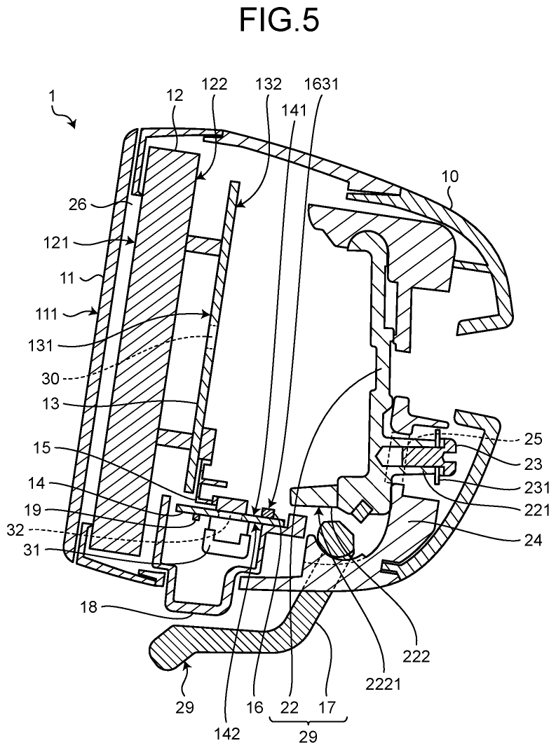

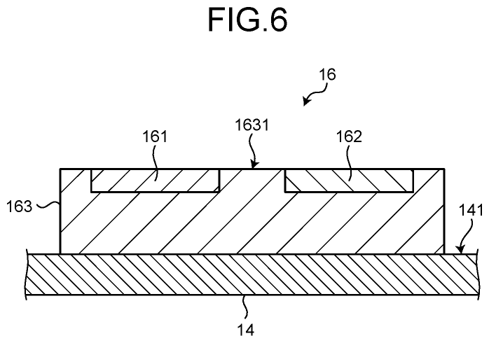

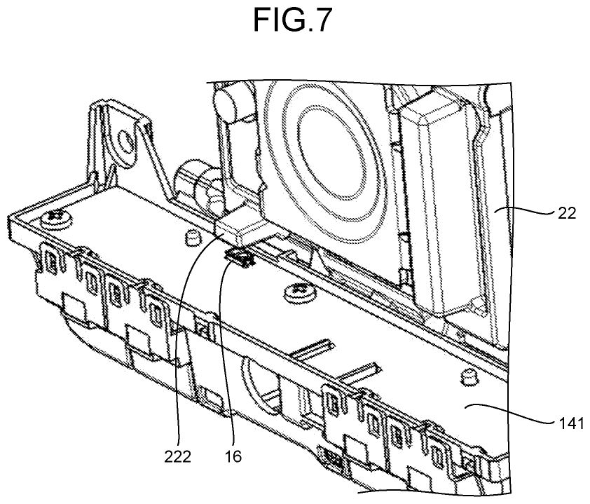

Details of the display device 1 in the first embodiment will be described with reference to FIGS. 2 to 7. FIG. 2 is a perspective view of the display device 1. FIG. 3 is a front view illustrating a structure of the display device 1. FIG. 4 is a cross-sectional view of the display device 1 taken along a cutting line A-A illustrated in FIG. 3 in a case where the display device 1 takes a first posture. FIG. 5 is a cross-sectional view of the display device 1 taken along the cutting line A-A illustrated in FIG. 3 in a case where the display device 1 takes a second posture. FIG. 6 is a front view schematically illustrating a structure of a sensor 16. FIG. 7 is a perspective view illustrating positions and sizes of the sensor 16 and a protruding part 222 in the case where the display device 1 takes the first posture. In FIGS. 4 and 5, illustration of various wirings and the like disposed inside the display device 1 is omitted in order to simplify the description. In a case where the display device 1 of the present disclosure is mounted, various wirings and the like may be appropriately disposed inside the display device 1.

The display device 1 is a device that is switched between a state of displaying an image and a state of displaying a mirror image, which is a reflected image, by a user's operation. The user is, for example, the occupant 6000. The display device 1 according to the first embodiment includes a transmission reflection member 11, a display panel 12, a first control circuit 30 that controls the display panel 12, the sensor 16, and an operating mechanism 29. The display device 1 may include a first substrate 13, a second substrate 14, and a panel operating mechanism 18. The display device 1 may include a housing 10 that supports the display panel 12, the transmission reflection member 11, the first substrate 13, the second substrate 14, and the panel operating mechanism 18.

The display device 1 is fixed to the vehicle 2000 by, for example, a mount 20, an arm 21, a plate 22, and a base (not illustrated). The display device 1 may include the mount 20, the arm 21, the plate 22, and the base. In the present embodiment, the operating mechanism 29 includes a lever 17 and the plate 22. The display device 1 may include a first illuminance sensor 27 and a second illuminance sensor 28. Alternatively, the display system 1000 may include the first illuminance sensor 27 and the second illuminance sensor 28. The first illuminance sensor 27 and the second illuminance sensor 28 may not be disposed in the display device 1.

The base is fixed to the vehicle 2000 and holds the mount 20. The base has a plate shape and is formed of a hard material. The hard material is, for example, metal. The base may have a shape that is longer in the front-rear direction than in the left-right direction. The base has an upper surface facing upward and a lower surface facing downward. The upper surface of the base is fixed to the vehicle 2000. The upper surface of the base is fixed to the windshield 4000 by, for example, an adhesive. As long as the display device 1 can be fixed at a position equivalent to that of a conventional room mirror, the base may be fixed by another method. A fixing strength in fixing the base to the vehicle 2000 is secured to such a degree that the base does not fall off from the vehicle 2000 even in a case where the display device 1 receives an external force due to an impact at the time of sudden stop or collision of the vehicle 2000.

The mount 20 is attached to the base to fix the display device 1 to the vehicle 2000.

The mount 20 has, for example, a shape that can be slid and assembled to the base. The mount 20 is formed of a rigid body. Here, the rigid body means an object that is not deformed when being slid and assembled to the base. The mount 20 is formed of, for example, an alloy such as aluminum, magnesium, or zinc. The mount 20 may be formed of filler-containing glass or filler-containing resin. At this time, the filler may be glass or carbon fiber.

The arm 21 connects the mount 20 and the plate 22. The arm 21 is connected to a lower part of the mount 20 and to the plate 22. The arm 21 has a shape that extends while curving downward and backward. The plate 22 is connected to the back of the housing 10.

The plate 22 supports the housing 10. The arm 21 and the plate 22 are formed of metal. The arm 21 and the plate 22 may be formed of, for example, resin. The mount 20 and the arm 21, the arm 21 and the plate 22, or the mount 20, the arm 21, and the plate 22 may be integrally formed. At this time, since the arm 21 is formed of the same material as the mount 20, the arm 21 may be a rigid body similarly to the mount 20. Since a known technique may be used for the connection between the mount 20 and the arm 21, the connection between the arm 21 and the plate 22, and a structure of the arm 21, the description thereof will be omitted.

The housing 10 supports the transmission reflection member 11, the display panel 12, the first substrate 13, and the second substrate 14. The housing 10 has an internal structure 24. The internal structure 24 has a gap 25. The housing 10 has, for example, a box shape, and the transmission reflection member 11, the display panel 12, the first substrate 13, and the second substrate 14 may be disposed inside the housing 10. The housing 10 may have a box shape that is long in the left-right direction. The housing 10 is supported by the plate 22. The housing 10 has an opening 26 on the front side of the display device 1. The display panel 12 is visually recognized from the opening 26 of the housing 10 on the front side of the display device 1. The transmission reflection member 11 is disposed at the front of the housing 10. The transmission reflection member 11 may be disposed so as to protect the display panel 12. In other words, the transmission reflection member 11 may be disposed so as to cover the front of the display panel 12 when viewed in the normal direction of a display surface 121 of the display panel 12.

In the present embodiment, a posture of the housing 10 in the case where the display device 1 takes the first posture may be referred to as the first posture. In addition, a posture of the housing 10 in the case where the display device 1 takes the second posture may be referred to as the second posture. The first posture is a posture of the display device 1 when the occupant 6000 confirms the rear of the vehicle by an image displayed on the display panel 12. The second posture is a posture of the display device 1 when the occupant 6000 confirms the rear of the vehicle 2000 by a mirror image reflected on the transmission reflection member 11.

In addition, a position of the housing 10 in the case where the display device 1 takes the first posture may be referred to as a third position. Moreover, a position of the housing 10 in the case where the display device 1 takes the second posture may be referred to as a fourth position. The occupant 6000 can switch a relative position of the sensor 16 with respect to the operating mechanism 29 between a first position and a second position different from the first position by operating the operating mechanism 29. The first position is a relative position of the sensor 16 with respect to the operating mechanism 29 in the case where the display device 1 takes the first posture. In addition, the second position is a relative position of the sensor 16 with respect to the operating mechanism 29 in the case where the display device 1 takes the second posture. By making the relative position of the sensor 16 with respect to the operating mechanism 29 different, it is easy to make the amount of light received by a light detection element 162 described later greatly different.

In the present embodiment, the occupant 6000 can switch a relative position of the housing 10 with respect to the plate 22 described later by operating the lever 17. More specifically, by operating the lever 17, the occupant 6000 can switch a relative position of the sensor 16 with respect to the protruding part 222 described later between the first position and the second position different from the first position. For example, the posture of the housing 10 may be switched between the first posture and the second posture by switching the position of the lever 17.

FIGS. 4 and 5 illustrate an example in which the posture of the housing 10 is switched by the lever 17, but the posture of the housing 10 may not be switched. For example, the lever 17 may be configured such that by operating the lever 17, the position of the plate 22 is switched and the posture of the housing 10 is not switched. Also in this configuration, the relative position of the sensor 16 with respect to the protruding part 222 can be switched. In addition, as means for switching the relative position of the sensor 16 with respect to the operating mechanism 29, the operating mechanism 29 may include, for example, a button instead of the lever 17.

The transmission reflection member 11 transmits part of incident light incident from the front side of the display device 1 and reflects part of the incident light. The transmission reflection member 11 has a surface 111. The transmission reflection member 11 includes a transparent plate that transmits incident light and a reflective polarizing layer located on the back side of the transparent plate. The transparent plate is formed of glass. The transparent plate may be formed of resin. When the transparent plate is formed of resin, the weight of the transparent plate is reduced as compared with a case where the transparent plate is formed of glass.

The reflective polarizing layer is attached to the transparent plate via an adhesive layer. The adhesive layer has a visible light transmittance of 80% or more. The reflective polarizing layer transmits first polarized light that is polarized in a first polarization direction among the light incident through the transparent plate. The reflective polarizing layer has a polarization transmission axis in the first polarization direction. The reflective polarizing layer reflects second polarized light that is polarized in a second polarization direction different from the first polarization direction. The reflective polarizing layer has a polarization reflection axis in the second polarization direction. In addition, the reflective polarizing layer transmits the first polarized light polarized in the first polarization direction among the light of the image displayed on the display panel 12.

Note that in the present embodiment, the first polarization direction and the second polarization direction are orthogonal to each other. As a polarization direction approaches the first polarization direction, the transmittance of light by the reflective polarizing layer increases, and as the polarization direction moves away from the first polarization direction, the transmittance of light by the reflective polarizing layer decreases. Similarly, as the polarization direction approaches the second polarization direction, the reflectance of light by the reflective polarizing layer increases, and as the polarization direction moves away from the second polarization direction, the reflectance of light by the reflective polarizing layer decreases. The reflective polarizing layer is, for example, a polarization reflection film.

In addition, the transmission reflection member 11 may include a reflectance control unit between the transparent plate and the reflective polarizing layer. In the reflectance control unit, a polarization absorption element, a first electrode, a control substance, and a second electrode overlap in this order in a direction from the transmission reflection member 11 toward the display panel 12. The reflectance control unit may include a first support plate that supports the first electrode and a second support plate that supports the second electrode. The first support plate is located between the polarization absorption element and the first electrode, and the second support plate is located between the second electrode and the reflective polarizing layer. The first electrode and the second electrode may be connected to a power supply (not illustrated). In a case where the first electrode and the second electrode have sufficient rigidity, the reflectance control unit may not include the first support plate and the second support plate.

The polarization absorption element transmits the first polarized light polarized in the first polarization direction and absorbs the second polarized light polarized in the second polarization direction, which is a different polarization direction from the first polarization direction. In the present embodiment, the first polarization direction and the second polarization direction are orthogonal to each other. As a polarization direction approaches the first polarization direction, the transmittance of light by the polarization absorption element increases, and as the polarization direction moves away from the first polarization direction, the transmittance of light by the polarization absorption element decreases. Similarly, as the polarization direction approaches the second polarization direction, the absorption rate of light by the polarization absorption element increases, and as the polarization direction moves away from the second polarization direction, the absorption rate of light by the polarization absorption element decreases. The first polarization direction and the second polarization direction may not be orthogonal to each other. In the polarization absorption element, in a case where the first polarization direction and the second polarization direction are not orthogonal to each other, a reflective polarizing layer in which the first polarization direction and the second polarization direction are not orthogonal to each other may be used. The polarization absorption element is, for example, a polarization absorption film.

The first electrode is a transparent electrode. The first electrode is, for example, an indium tin oxide (ITO) electrode. The first electrode may be supported by the first support plate. The first support plate is formed of a transparent material. The first support plate is, for example, a glass plate. For example, the first electrode may be supported by the first support plate by forming the first electrode on the first support plate by vapor deposition.

The second electrode is a transparent electrode. The second electrode is, for example, an ITO electrode. The second electrode may be supported by the second support plate. The second support plate is formed of a transparent material. The second support plate is, for example, a glass plate. For example, the second electrode may be supported by the second support plate by forming the second electrode on the second support plate by vapor deposition.

The control substance is located between the first electrode and the second electrode.

The reflectance of the transmission reflection member 11 changes in accordance with a state of the control substance that varies with a potential difference between the first electrode and the second electrode. Specifically, by changing a voltage applied between the first electrode and the second electrode, the state of the control substance changes, and the reflectance of the transmission reflection member 11 changes. As a result, for example, the reflectance of the transmission reflection member 11 can be changed with an environment around the vehicle 2000. The control substance is, for example, liquid crystal molecules. The control substance may be, for example, an electrochromic material. In a case where the control substance is an electrochromic material, the reflectance control unit may not include the polarization absorption element and the reflective polarizing layer described later.

The display panel 12 displays an image. More specifically, the display panel 12 displays an image captured in the imaging device 3000. The display panel 12 is located on the back side of the transmission reflection member 11. The display panel 12 includes the display surface 121 and a fifth surface 122 opposed to the display surface 121. The display surface 121 and the fifth surface 122 are parallel to each other. In addition, the surface 111 and the display surface 121 are parallel to each other. The display panel 12 can be switched on and off. In other words, the display panel 12 can be switched between an ON state in which an image is displayed and an OFF state in which no image is displayed. The display panel 12 is, for example, a liquid crystal display or an organic electro-luminescence (EL) display. Note that the display panel 12 may display, without being limited to an image captured by the imaging device 3000, an image captured by another imaging device. Another imaging device is an imaging device that is connected to the display device 1 in a wired or wireless manner and is different from the imaging device 3000.

The first illuminance sensor 27 detects illuminance at the front of the vehicle 2000. The second illuminance sensor 28 detects illuminance at the rear of the vehicle 2000. In the present embodiment, the first illuminance sensor 27 is disposed at the back of the housing 10. In addition, in the present embodiment, the second illuminance sensor 28 is disposed at the front of the housing 10. The first control circuit 30 may change the luminance of the image displayed on the display panel 12 according to the brightness of the front and rear of the vehicle 2000 detected by the first illuminance sensor 27 and the second illuminance sensor 28. In addition, the reflectance of the reflectance control unit may be changed according to the brightness of the front and rear of the vehicle 2000 detected by the first illuminance sensor 27 and the second illuminance sensor 28.

The first illuminance sensor 27 and the second illuminance sensor 28 are, for example, silicon photosensors. The second illuminance sensor 28 may be attached to the rear of the vehicle 2000 so that the intensity of light applied to the vehicle 2000 from the rear of the vehicle 2000 can be detected. Alternatively, the imaging device 3000 may function as the second illuminance sensor 28.

The first substrate 13 is located on the back side of the display panel 12. The first substrate 13 has a third surface 131 and a fourth surface 132. The third surface 131 and the fourth surface 132 are parallel to each other. In addition, the fifth surface 122 and the third surface 131 face each other and are parallel to each other.

The second substrate 14 is located on the back side of the display panel 12. The second substrate 14 has a sixth surface 141 perpendicular to the fifth surface 122 and a seventh surface 142 opposed to the sixth surface 141. In the present embodiment, the sixth surface 141 faces upward.

A panel operating mechanism 18 for operating the display panel 12 may be provided below the second substrate 14. For example, the second substrate 14 includes a pressed part 31 and a second control circuit 32. The panel operating mechanism 18 supports the second substrate 14. The pressed part 31 and the second control circuit 32 may be electrically connected. The second control circuit 32 may receive a signal from the pressed part 31 and transmit the signal to the first control circuit 30. The panel operating mechanism 18 includes, for example, a projection (not illustrated). When the user presses the panel operating mechanism 18, the pressed part 31 is pressed by the projection. When pressed, the pressed part 31 outputs a signal to the second control circuit 32. The second control circuit 32 transmits the signal output from the pressed part 31 to the first control circuit 30. When detecting the signal transmitted from the second control circuit 32, the first control circuit 30 changes a display content of the display panel 12. As a result, the user can operate, for example, a menu screen of the display panel 12 by operating the panel operating mechanism 18. The panel operating mechanism 18 has a button shape. As long as the display panel 12 can be operated by operating the panel operating mechanism 18, the panel operating mechanism 18 is not limited to the button shape. In the present embodiment, the panel operating mechanism 18 is four buttons. The number of buttons is not limited to four. For example, the number of buttons may be less than four. In addition, the number of buttons may be five or more. In addition, the second substrate 14 may include an LED 19. For example, the first control circuit 30 controls the LED 19. The LED 19 illuminates the panel operating mechanism 18. As a result, the user can easily operate the panel operating mechanism 18 even when it is dark inside the vehicle.

The first substrate 13 and the second substrate 14 are connected by a flexible flat cable (FFC) 15. The FFC 15 may be provided anywhere on the first substrate 13 and the second substrate 14. The first substrate 13 and the second substrate 14 may be connected by, for example, a B-to-B connector.

The sensor 16 includes a light emission element 161, the light detection element 162, and a base material 163. The sensor 16 is located on the sixth surface 141. By providing the sensor 16 on the second substrate 14 including the LED 19 and the second control circuit 32, the display device 1 does not need to include an additional substrate for providing the sensor 16. Therefore, the display device 1 can be downsized. The base material 163 supports the light emission element 161 and the light detection element 162. The base material 163 has a first surface 1631. The light emission element 161 and the light detection element 162 are located on the first surface 1631. The light emission element 161 and the light detection element 162 are located on the same plane. The light emission element 161 emits light upward. In a case where a detection target is present at a position where the light emitted by the light emission element 161 is blocked, namely, present above the light emission element 161, the light emitted by the light emission element 161 is reflected by the detection target.

The light detection element 162 receives reflected light of the light emitted by the light emission element 161, namely, receives light reflected by the detection target. In the present embodiment, the detection target is the protruding part 222 described later. The sensor 16 changes a signal to be output according to a change in light received by the light detection element 162. In the present embodiment, the light detection element 162 is a phototransistor.

The light detection element 162 generates a current having a magnitude corresponding to the amount of received light. For example, the light detection element 162 generates a larger current as the amount of received light is larger. In the example illustrated in FIG. 6, the first surface 1631 is the outermost surface of the base material 163, but the first surface 1631 may be provided inside the outermost surface of the base material 163. For example, the base material 163 may have a first recess and a second recess that are recessed downward from the outermost surface. The first recess and the second recess may have flat bottom surfaces at the same distance from the outermost surface of the base material 163. In this example, a cross section of the base material 163 including the bottom surface of the first recess and the bottom surface of the second recess is the first surface 1631. For example, the light emission element 161 may be located on the bottom surface of the first recess, and the light detection element 162 may be located on the bottom surface of the second recess.

Like the sensor 16, a sensor including a light emission element, a light detection element, and a base material and having a structure in which the light emission element and the light detection element are located on the same plane may be referred to as a reflector sensor. An example of an optical sensor other than the reflector sensor is a photointerrupter. The photointerrupter includes a base material having a valley shape, a light emission element located on a surface of the base material, and a light detection element located on a surface of the base material. The light emission element and the light detection element are located so as to face each other via a valley of the base material.

In a case where a detection target exists in a space between the light emission element and the light detection element, the detection target blocks light from the light emission element, and thus the light detection element does not receive the light. On the other hand, in a case where the detection target does not exist in the space between the light emission element and the light detection element, the light emitted by the light emission element is incident on the light detection element without being blocked. As a result, the photointerrupter can detect the presence or absence of the detection target on the basis of whether the light detection element receives the light.

However, in the photointerrupter, since the base material needs to have a valley with a depth and a width enough for the detection target to enter between the light emission element and the light detection element, the size tends to be large compared to the reflector sensor that does not need to provide a valley.

Therefore, by adopting the reflector sensor, the housing 10 can be downsized as compared with, for example, a case where the photointerrupter is adopted.

The light emission element 161 and the light detection element 162 are arranged in the longitudinal direction of the first surface 1631. In other words, the light emission element 161 and the light detection element 162 are arranged in the left-right direction. The light emission element 161 and the light detection element 162 may be arranged in the lateral direction of the first surface 1631. In other words, the light emission element 161 and the light detection element 162 may be arranged in the front-rear direction. The farther the sensor 16 is provided on the back side, the shorter the protruding part 222 extending from the back side to the front side described later can be.

In addition, as illustrated in FIG. 4, in the case where the housing 10 takes the first posture, the sensor 16 may be provided anywhere on the sixth surface 141 as long as the light emission element 161 and a second surface 2221 overlap at least partially when viewed in the normal direction of the first surface 1631.

The first substrate 13 includes the first control circuit 30 that controls the display panel 12. The first control circuit 30 monitors, at regular intervals, a voltage having a magnitude corresponding to the current output by the light detection element 162, and in a case where the first control circuit 30 detects that the magnitude of the voltage is equal to or greater than a threshold, the first control circuit 30 brings the display panel 12 into a state of not displaying an image. The state in which the display panel 12 does not display an image is, for example, a state in which the display panel 12 is turned off. In addition, in a case where the first control circuit 30 detects that the magnitude of the voltage is equal to or less than the threshold, the first control circuit 30 brings the display panel 12 into a state of displaying an image. The state in which the display panel 12 displays an image is, for example, a state in which the display panel 12 is turned on. The first control circuit 30 may control the display panel 12 on the basis of a signal other than the voltage. In addition, the first control circuit 30 changes, for example, the display content of the display panel 12 according to the operation on the panel operating mechanism 18.

The plate 22 supports the housing 10. The plate 22 is located on the back side of the first substrate 13. The plate 22 has a projecting part 221 and the protruding part 222. The projecting part 221 has a recess 2211. The projecting part 221 passes through the gap 25 and extends in a direction from the front side to the back side of the housing 10. The recess 2211 holds a screw 23 at an end. The screw 23 includes a locking part 231. The screw 23 and the locking part 231 are separate components. In addition, the screw 23 and the locking part 231 may be integrally formed. The locking part 231 is located on the back side with respect to the gap 25.

The protruding part 222 extends in a direction from the display panel 12 toward the transmission reflection member 11. The protruding part 222 has the second surface 2221 facing the first surface 1631. The second surface 2221 is a surface facing the first surface 1631 when the relative position of the sensor 16 with respect to the operating mechanism 29 is the first position. As illustrated in FIG. 4, in the case where the housing 10 takes the first posture, the first surface 1631 and the second surface 2221 face each other and are parallel to each other. In the case where the display device 1 takes the first posture, the second surface 2221 reflects the light emitted by the light emission element 161. The amount of light emitted by the light emission element 161 and reflected by the second surface 2221 is different between the case where the posture of the housing 10 is the first posture and the case where the posture is the second posture.

The protruding part 222 is provided at a lower end of the plate 22 and on the left side thereof. The protruding part 222 may be provided anywhere in the left-right direction of the plate 22. For example, the protruding part 222 may be provided at the lower end of the plate 22 and on the right side thereof. In addition, as long as the second surface 2221 can reflect the light emitted by the light emission element 161, the protruding part 222 may not be provided at the lower end of the plate 22.

The plate 22 and the protruding part 222 are integrally formed of metal. In addition, the plate 22 and the protruding part 222 may be formed of different materials. The protruding part 222 may be formed of a reflective material. By appropriately selecting the type of the reflective material and the manufacturing method, it is possible to obtain the second surface 2221 having a reflectance of a desired value. The reflective material is, for example, resin.

The plate 22 formed of metal and the protruding part 222 formed of resin may be bonded to each other. In this case, the resin forming the protruding part 222 is, for example, an acrylonitrile butadiene styrene (ABS) resin, a polypropylene (PP) resin, or a polymethyl methacrylate (PMMA) resin.

In a case where the plate 22 and the protruding part 222 are integrally formed of metal, the reflectance of light on the second surface 2221 may be different among display devices at the time of manufacturing the plate 22. Therefore, a display device in which the reflectance of light on the second surface 2221 does not have a desired value may be manufactured. On the other hand, by forming the protruding part 222 separately from the plate 22, it is easy to set the reflectance of the second surface 2221 to a desired value.

In addition, a reflection sheet using resin as a material may be attached to a surface of the protruding part 222 facing the first surface 1631, and a reflection surface of the reflection sheet may be the second surface 2221. In this case, the resin used for the reflection sheet is, for example, a polyester (PES) resin or a polyethylene terephthalate (PET) resin. By attaching the reflection sheet to the surface facing the first surface 1631, it is easy to set the reflectance of light on the second surface 2221 to a desired value. The reflectance can be set to a desired value by appropriately selecting the type of the resin used as a material for the reflection sheet and the manufacturing method. By setting the reflectance of the second surface 2221 to a desired value, the first control circuit 30 can more accurately determine on and off of the display panel 12.

In the present embodiment, since the operating mechanism 29 includes the lever 17 and the plate 22, the protruding part 222 having the second surface 2221 can be provided on the plate 22. As a result, the degree of freedom in design is improved, and thus, for example, the second surface 2221 can be provided at a position closer to the sensor 16. Therefore, by making the relative position of the sensor 16 with respect to the operating mechanism 29 different, it is easy to make the amount of light received by the light detection element 162 greatly different.

In addition, in the present embodiment, the posture of the housing 10 is switched by the lever 17. However, in a case where the posture of the housing 10 is not switched, the display device 1 may not include the plate 22. For example, the lever 17 may reflect the light emitted by the light emission element 161. For example, the lever 17 may have a protruding part extending in the direction from the display panel 12 toward the transmission reflection member 11. At this time, in the display device 1, a relative position between the protruding part of the lever 17 and the sensor 16 may be switched by operating the lever 17. As a result, the display device 1 can be switched on and off with a simple configuration. Therefore, the weight of the display device 1 can be reduced. In addition, similarly to the case where the plate 22 and the protruding part 222 are formed of different materials, the lever 17 and the protruding part may be formed of different materials. The protruding part may be formed of a reflective material. In addition, a reflection sheet using resin as a material may be attached to a surface of the protruding part facing the first surface 1631.

In the present embodiment, the second substrate 14 is located below the first substrate 13, but the sensor 16 can be provided on the seventh surface 142 when the second substrate is provided farther on the upper side. For example, the protruding part 222 is located below the second substrate 14.

When the display device 1 is used, the occupant 6000 can switch between a state in which an image obtained by capturing the rear of the vehicle 2000 is displayed on the display panel 12 and the rear of the vehicle 2000 is confirmed by viewing the image and a state in which the rear of the vehicle 2000 is reflected on the transmission reflection member 11 and the rear of the vehicle 2000 is confirmed by viewing the mirror image.

In a case where the occupant 6000 confirms the rear of the vehicle 2000 by the image displayed on the display panel 12, the image displayed on the display panel 12 is visually recognized by the occupant 6000 through the transmission reflection member 11. In addition, in a case where the occupant 6000 confirms the rear of the vehicle 2000 by the transmission reflection member 11, the display panel 12 takes either a state of not displaying the image or a state of displaying a black image on the entire surface. In a case where the display panel 12 does not display the image or in a case where the black image is displayed on the entire surface, the display panel 12 is difficult to be visually recognized by the occupant 6000 through the transmission reflection member 11.

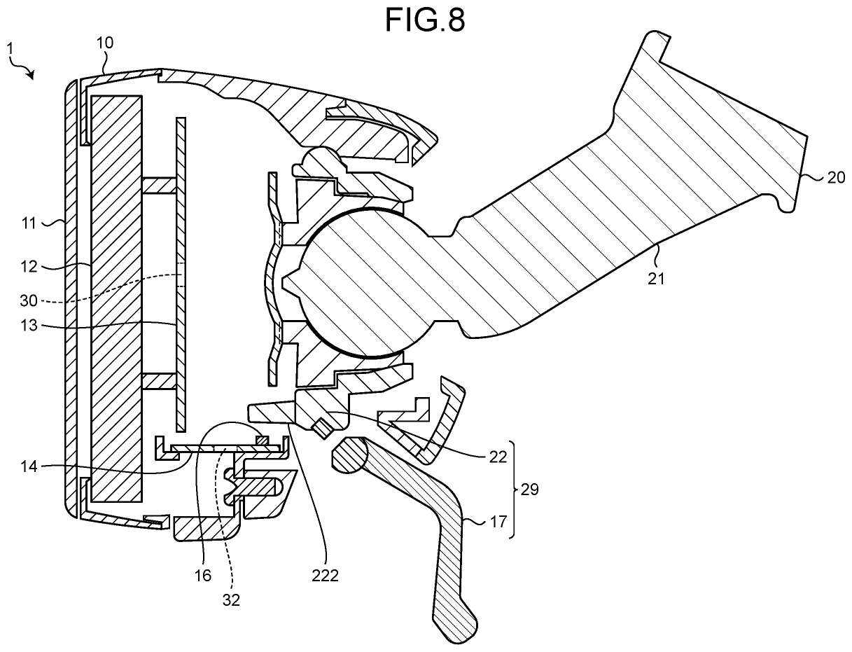

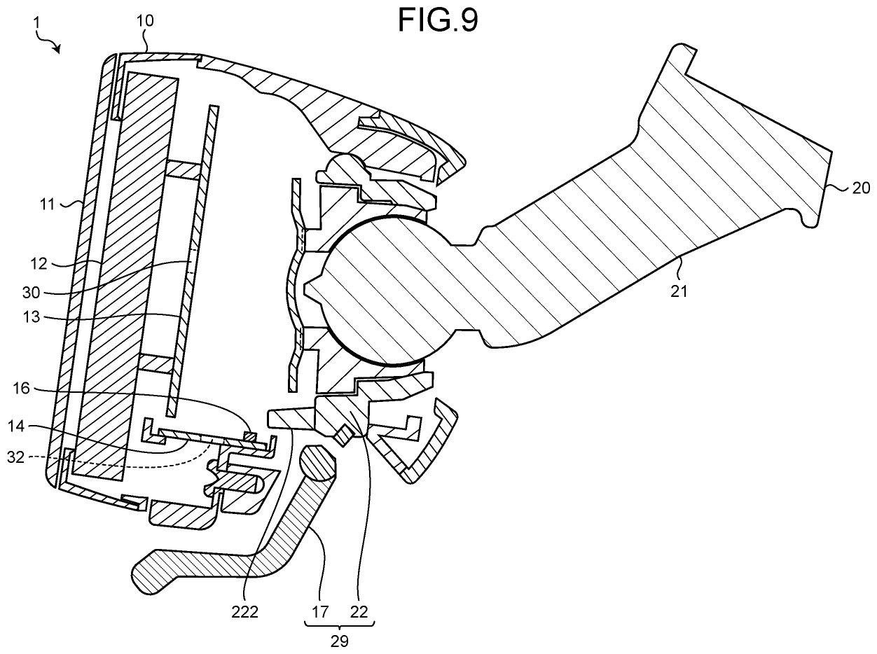

Switching of the posture of the housing 10 and each posture will be described in detail with reference to FIGS. 4, 5, 8, and 9. FIG. 8 is a cross-sectional view of the display device 1 taken along a cutting line B-B illustrated in FIG. 3 in the case where the display device 1 takes the first posture. FIG. 9 is a cross-sectional view of the display device 1 taken along the cutting line B-B illustrated in FIG. 3 in the case where the display device 1 takes the second posture.

As described above, the first posture is the posture of the display device 1 when the occupant 6000 confirms the rear of the vehicle by the image displayed on the display panel 12, and the second posture is the posture of the display device 1 when the occupant 6000 confirms the rear of the vehicle 2000 by the mirror image reflected on the transmission reflection member 11. As illustrated in FIGS. 4, 5, 7, and 8, when the position of the lever 17 is switched, the posture of the display device 1 is changed, and the relative position of the sensor 16 with respect to the protruding part 222 is switched. Specifically, when the lever 17 is operated to the front of the display device 1, namely, operated to move close to the occupant 6000, the display device 1 is switched to the first posture. On the other hand, when the lever 17 is operated to the rear of the display device 1, namely, operated to move away from the occupant 6000, the display device 1 is switched to the second posture.

When the posture is switched from the second posture to the first posture, the housing 10 moves to a position where the internal structure 24 and the locking part 231 are in contact with each other. In addition, when the posture is switched from the first posture to the second posture, the housing 10 moves to a position where the housing 10 and the lower end of the plate 22 are in contact with each other. In the second posture, the position of the plate 22 in contact with the housing 10 may not be the lower end of the plate 22. As illustrated in FIG. 5, plural regions on the plate 22 may be in contact with the housing 10. Alternatively, only one optional position on the plate 22 may be in contact with the housing 10.

Comparing the first posture and the second posture, the normal direction of the surface 111 is directed upward more in the second posture than in the first posture. When the housing 10 takes the second posture, the transmission reflection member 11 is in a state in which a ceiling of a vehicle interior is reflected thereon when viewed from the occupant 6000.

Therefore, the reflected light reflected by the transmission reflection member 11 is less likely to travel toward the occupant 6000. In the case where the occupant 6000 confirms the rear of the vehicle by the image displayed on the display panel 12, the housing 10 is set to the second posture. With this setting, it is possible to avoid incidence of bright ambient light applied from the rear of the vehicle 2000 on the eyes of the occupant 6000. The ambient light applied from the rear of the vehicle 2000 is, for example, light from a headlight of a following vehicle. As a result, the visibility of the image displayed on the display panel 12 can be improved. Note that the first control circuit 30 may perform image display on the display surface 121 only when the housing 10 takes the first posture. Thus, the occupant 6000 can easily visually recognize the display image in the case where the display device 1 takes the first posture and the mirror image in the case where the display device 1 takes the second posture.

As illustrated in FIGS. 8 and 9, when the posture of the housing 10 is switched by operating the lever 17, the positions of the base, the arm 21, and the plate 22 do not change, and the postures of the housing 10 and the members supported by the housing 10 change. As a result, the positional relationship between the sensor 16 and the protruding part 222 changes.

Specifically, in the case where the housing 10 takes the first posture, the first surface 1631 and the second surface 2221 overlap when viewed in the normal direction of the first surface 1631. As a result, in the case where the housing 10 takes the first posture, the light emitted by the light emission element 161 is reflected by the second surface 2221. On the other hand, in the case where the housing 10 takes the second posture, the first surface 1631 and the second surface 2221 do not overlap when viewed in the normal direction of the first surface 1631. As a result, in the case where the housing 10 takes the second posture, the light emitted by the light emission element 161 is not reflected by the second surface 2221. The amount of light received by the light detection element 162 can be changed by changing an overlapping area of the operating mechanism 29 and the sensor 16. As a result, the amount of reflected light received by the light detection element 162, the reflected light being the light emitted by the light emission element 161 and reflected by the second surface 2221, is smaller in the case where the housing 10 takes the second posture than in the case where the housing 10 takes the first posture. Therefore, the current generated by the light detection element 162 is smaller in the case where the housing 10 takes the second posture than in the case where the housing 10 takes the first posture.

The reflectance of the second surface 2221 may be 10% or more. It is assumed here that a condition where the posture of the housing 10 has been switched is detected by determining, on the basis of magnitude of the current output by the light detection element 162, whether to be in a state that the light detection element 162 receives light emitted by the light emission element 161 and reflected by the second surface 2221, or in a state that light emitted by the light emission element 161 is not reflected by the second surface 2221. Even when the light emitted by the light emission element 161 is not reflected by the second surface 2221, the current may be generated by the light detection element 162 due to reception of background light such as reflected light from another element or natural light. Hereinafter, such a current is called a background current. If the reflectance of the second surface 2221 is low, it may be difficult to determine whether the current output from the light detection element 162 is the current generated by receiving light emitted from the light emission element 161 and reflected by the second surface 2221, or is the above-noted background current. Therefore, in order for the sensor 16 to detect that the posture of the housing 10 has been switched, it is required that an amount of light to be received by the light detection element 162 due to change in the posture of the housing 10 is changed by a given level or more. In other words, it is required that an amount of light to be reflected by the second surface 2221 changes so as to become a given level or more.

When the reflectance of the second surface 2221 is 10% or more, the amount of light to be reflected by the second surface 2221 tends to become a given level or more. In other words, the current output from the light detection element 162 easily becomes a level for making determination that this current is not the background current. Therefore, when the reflectance of the second surface 2221 is 10% or more, it is easy for the sensor 16 to detect the condition where the posture of the housing 10 has been switched.

The reflectance of the second surface 2221 may be 20% or more. When the reflectance of the second surface 2221 is 20% or more, an amount of light to be reflected by the second surface 2221 due to change in the posture of the housing 10 further increases.

Therefore, the possibility that the current output from the light detection element 162 becomes a level for making determination that this current is not the background current is enhanced. Thus, the sensor 16 is able to easily detect the condition where the posture of the housing 10 has been switched.

A distance between the first surface 1631 and the second surface 2221 in a state where the housing 10 takes the first posture may be 0.5 mm or more. If the first surface 1631 is located too close to the second surface 2221, reflected light from the second surface 2221 is difficult to enter the light detection element 162, and thereby the current output from the light detection element 162 may decrease. In such a case, it may be difficult to determine whether the current output from the light detection element 162 is the current generated by receiving light emitted from the light emission element 161 and reflected by the second surface 2221, or is the background current. Therefore, by setting the distance between the first surface 1631 and the second surface 2221 to be 0.5 mm or more, the current output from the light detection element 162 easily becomes a level for making determination that this current is not the background current.

The distance between the first surface 1631 and the second surface 2221 in the state where the housing 10 takes the first posture may be 4.5 mm or less. This is because, if the first surface 1631 is located too far from the second surface 2221, reflected light from the second surface 2221 is difficult to enter the light detection element 162. By setting the distance between the first surface 1631 and the second surface 2221 to be 4.5 mm or less, the current output from the light detection element 162 easily becomes a level for making determination that this current is not the background current.

The distance between the first surface 1631 and the second surface 2221 in the state where the housing 10 takes the first posture may be 1.0 mm or more and 3.0 mm or less (namely, be in a range between 1.0 mm and 3.0 mm inclusive). By setting the distance between the first surface 1631 and the second surface 2221 to be in a range between 1.0 mm and 3.0 mm inclusive, the current output from the light detection element 162 more easily becomes a level for making determination that this current is not the background current. Thus, the sensor 16 is able to easily detect the condition where the posture of the housing 10 has been switched.

As long as the amount of light received by the light detection element 162 changes between the case where the housing 10 takes the first posture and the case where the housing 10 takes the second posture, the first surface 1631 and the second surface 2221 may partially overlap when viewed in the normal direction of the first surface 1631 in the case where the housing 10 takes the second posture. In this case, an overlapping area of the first surface 1631 and the second surface 2221 when viewed in the normal direction of the first surface 1631 is smaller in the case where the housing 10 takes the second posture than in the case where the housing takes the first posture.

For convenience of description, an edge of the second surface 2221 in the negative direction of the z-axis is referred to as a reflection surface edge. An amount of change in a position of the reflection surface edge in the z-axis direction between a case where the housing 10 takes the first posture and a case where the housing takes the second posture may be 1.0 mm or more. If the amount of change in the position of the reflection surface edge in the z-axis direction is too small, there is a possibility that the change in amount of light entering the light detection element 162 decreases between the case where the housing 10 takes the first posture and the case where the housing takes the second posture. Thus, an amount of change in the current output from the light detection element 162 may also decrease. By setting, to be 1.0 mm or more, the amount of change in the position of the reflection surface edge in the z-axis direction between the case where the housing 10 takes the first posture and the case where the housing takes the second posture, the change in the amount of light entering the light detection element 162 easily becomes a given level or more. Therefore, the amount of change in the current output from the light detection element 162 can easily become a given level or more, and the sensor 16 is able to easily detect the condition where the posture of the housing 10 has been switched.

The amount of change in the position of the reflection surface edge in the z-axis direction between a case where the housing 10 takes the first posture and a case where the housing takes the second posture may be 3.0 mm or more. With this configuration, the change in the amount of light entering the light detection element 162 easily becomes large. Therefore, the amount of change in the current output from the light detection element 162 can easily become large, and the sensor 16 is able to easily detect the condition where the posture of the housing 10 has been switched.

The amount of change in the position of the reflection surface edge in the z-axis direction between a case where the housing 10 takes the first posture and a case where the housing takes the second posture may be 8.0 mm or less. By setting the amount of change in the position of the reflection surface edge to be 8.0 mm or less, the sensor 16 is able to easily detect the condition where the posture of the housing 10 has been switched, without causing the housing 10 to increase in size.

Upon the occupant 6000 operates the lever 17 to switch the posture of the housing 10, the sensor 16 detects that the posture of the housing 10 has been switched. As described above, the first control circuit 30 switches on and off of the display panel 12 on the basis of the detection result of the sensor. Therefore, the occupant 6000 can switch both the posture of the housing 10 and on and off of the display panel only by operating the lever 17. In the present embodiment, in the case where the housing 10 takes the first posture, the first control circuit 30 brings the display panel 12 into the state of not displaying an image. Therefore, in the case where the relative position of the sensor 16 with respect to the operating mechanism 29 is the first position, the display panel 12 is hardly visually recognized by the occupant 6000 through the transmission reflection member 11. The case where the relative position of the sensor 16 with respect to the operating mechanism 29 is the first position is, in other words, the case where the housing 10 takes the first posture. In addition, in the case where the housing 10 takes the second posture, the first control circuit 30 brings the display panel into the state of displaying an image. Note that the first control circuit 30 may bring the display panel into the state of displaying an image in the case where the housing 10 takes the first posture, and bring the display panel into the state of not displaying an image in the case where the housing 10 takes the second posture. At this time, in the case where the relative position of the sensor 16 with respect to the operating mechanism 29 is the second position, the display panel 12 is hardly visually recognized by the occupant 6000 through the transmission reflection member 11. The case where the relative position of the sensor 16 with respect to the operating mechanism 29 is the second position is, in other words, the case where the housing 10 takes the second posture.

As described above, the display device 1 of the present embodiment includes the transmission reflection member 11, the display panel 12, the first control circuit 30, the sensor 16, and the operating mechanism 29. The transmission reflection member 11 transmits part of incident light and reflects part of the incident light. The display panel 12 displays an image.

The first control circuit 30 controls the display panel 12. The sensor 16 includes the light emission element 161, the light detection element 162 that receives reflected light of light emitted by the light emission element 161, and the base material 163 having the first surface 1631. The light emission element 161 and the light detection element 162 are located on the first surface 1631. The operating mechanism 29 switches the relative position of the sensor 16 with respect to the operating mechanism 29 between the first position and the second position different from the first position, and changes the amount of light received by the light detection element. The first control circuit 30 switches on and off of the display panel 12 on the basis of the amount of light received by the light detection element 162.

As described above, in the display device 1 of the present embodiment, the sensor includes the light emission element, the light detection element, and the base material, and has the structure in which the light emission element and the light detection element are located on the same plane. The display device 1 of the present embodiment can use a small sensor as compared with a related art. Therefore, the display device 1 of the present embodiment can be downsized.

In the present embodiment, the display device 1 includes one sensor 16, but the number of sensors may be two or more. By providing two or more sensors, the first control circuit 30 can detect the postures of three or more housings 10. For example, in a case where a sensor 16a including a light emission element 161a and a light detection element 162a is provided side by side with the sensor 16 on the front side of the sensor 16 on the sixth surface 141, the first control circuit 30 can detect the postures of the three housings with a voltage having a magnitude corresponding to a current flowing through the sensor 16 and the sensor 16a. The three postures are, for example, a posture in which the light detection element 162 and the light detection element 162a receive reflected light of light emitted by the light emission element 161 and the light emission element 161a, a posture in which only the light detection element 162 receives reflected light of light emitted by the light emission element 161, and a posture in which neither the light detection element 162 nor the light detection element 162a receives reflected light. By increasing the number of sensors, it is possible to detect more postures.

### Second Embodiment

Hereinafter, a second embodiment of a display device according to the present disclosure will be described with reference to the drawings.

The display system 1000 in the present embodiment is different from that in the first embodiment in the position of the sensor 16 and the position of the second surface 2221.

Since the other configurations are similar to those of the display system 1000 of the first embodiment, the same components as those of the display system 1000 of the first embodiment are denoted by the same reference numerals, and the description thereof will be omitted.

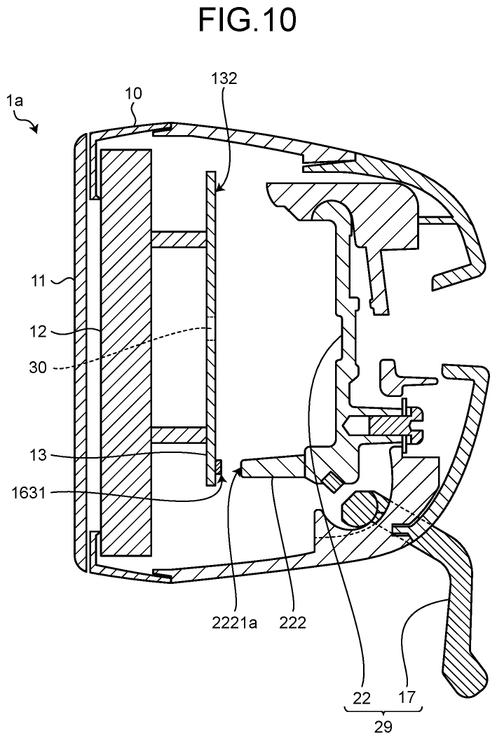

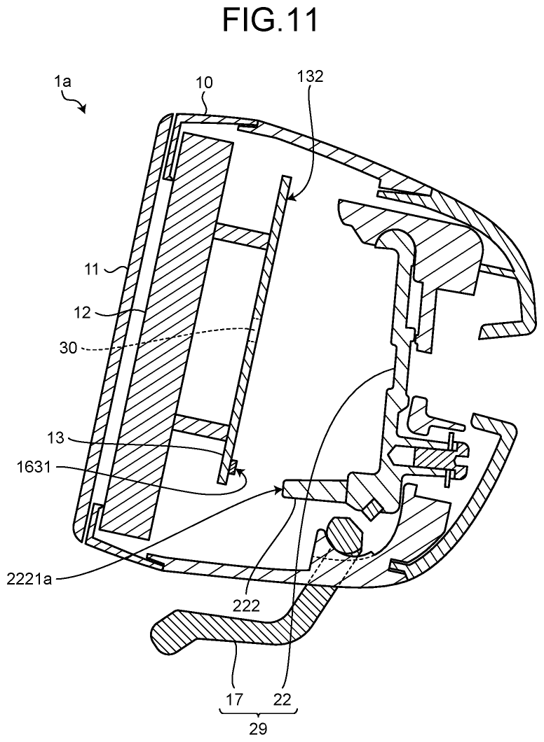

FIG. 10 is a cross-sectional view of a display device 1a taken along the cutting line A-A illustrated in FIG. 3 in a case where the display device takes the first posture. FIG. 11 is a cross-sectional view of the display device 1a taken along the cutting line A-A illustrated in FIG. 3 in a case where the display device takes the second posture.

In the display device 1a according to the second embodiment, the sensor 16 is located on a lower part of the fourth surface 132. The protruding part 222 has a second surface 2221a facing the first surface 1631. As illustrated in FIG. 10, in the case where the display device 1a takes the first posture, the sensor 16 may be located anywhere on the fourth surface 132 as long as the light emission element 161 and the second surface 2221a overlap when viewed in the normal direction of the first surface 1631.

As illustrated in FIGS. 10 and 11, when the position of the lever 17 is switched, the posture of the housing 10 is changed, and the relative position of the sensor 16 with respect to the protruding part 222 is switched. Specifically, when the lever 17 is operated to the front of the display device 1a, namely, to move close to the occupant 6000, the housing 10 is switched to the first posture. On the other hand, when the lever 17 is operated to the rear of the display device 1, namely, to move away from the occupant 6000, the housing 10 is switched to the second posture.

In the case where the housing 10 takes the first posture, the first surface 1631 and the second surface 2221a overlap when viewed in the normal direction of the first surface 1631. As a result, in the case where the housing 10 takes the first posture, the light emitted by the light emission element 161 is reflected by the second surface 2221a of the protruding part 222. On the other hand, in the case where the housing 10 takes the second posture, the first surface 1631 and the second surface 2221a do not overlap when viewed in the normal direction of the first surface 1631. As a result, in the case where the housing 10 takes the second posture, the light emitted by the light emission element 161 is not reflected by the second surface 2221a. Therefore, the amount of reflected light received by the light detection element 162, the reflected light being the light emitted by the light emission element 161 and reflected by the second surface 2221a, is smaller in the case where the housing 10 takes the second posture than in the case where the housing 10 takes the first posture. Therefore, the current generated by the light detection element 162 is smaller in the case where the housing 10 takes the second posture than in the case where the housing 10 takes the first posture.

As long as the amount of light received by the light detection element 162 changes between the case where the housing 10 takes the first posture and the case where the housing 10 takes the second posture, the first surface 1631 and the second surface 2221a may partially overlap when viewed in the normal direction of the first surface 1631 in the case where the housing 10 takes the second posture. In this case, an overlapping area of the first surface 1631 and the second surface 2221a when viewed in the normal direction of the first surface 1631 is smaller in the case where the housing 10 takes the second posture than in the case where the housing takes the first posture.

In addition, the display device 1a may be configured to switch on and off of the display panel 12 by changing a distance between the first surface 1631 and the second surface 2221a by operating the lever 17. Specifically, when the plate 22 moves in a direction in which the second surface 2221a moves away from the first surface 1631, the light emitted by the light emission element 161 is difficult to reach the second surface 2221a, and thus, the amount of light received by the light detection element 162 decreases. On the other hand, when the plate 22 moves in a direction in which the second surface 2221a moves close to the first surface 1631, the light emitted by the light emission element 161 easily reaches the second surface 2221a, and thus, the amount of light received by the light detection element 162 increases. The amount of light received by the light detection element 162 can be changed by changing the distance between the operating mechanism 29 and the sensor 16. As a result, the first control circuit 30 can switch on and off of the display panel 12 according to the amount of light received by the light detection element 162. In addition, the housing 10 may move in a direction in which the first surface 1631 moves close to or away from the second surface 2221a. Alternatively, the first substrate 13 may move in the direction in which the first surface 1631 moves close to or away from the second surface 2221a.

The configuration to switch on and off of the display panel 12 by changing the distance between the first surface 1631 and the second surface 2221a is also applicable to the first embodiment. In FIG. 4, when the plate 22 is configured to move in the up-down direction by operating the lever 17, the distance between the first surface 1631 and the second surface 2221 changes. At this time, the first control circuit 30 can switch on and off of the display panel 12 according to the amount of light received by the light detection element 162.

In addition, in the display device 1a of the second embodiment, since the sensor 16 is provided on the fourth surface 132 of the first substrate 13, it is not necessary to provide the second substrate 14 of the display device 1 of the first embodiment. Therefore, in the display device 1a of the second embodiment, it is possible to reduce the number of components and the weight of the display device 1 of the first embodiment.

Although the embodiments of the present disclosure have been described above, the above-described embodiments are presented as examples, and are not intended to limit the scope of the invention. These novel embodiments can be implemented in various other forms, and various omissions, substitutions, and changes can be made without departing from the gist of the invention. These novel embodiments and modifications thereof are included in the scope and gist of the invention, and are included in the invention described in the claims and the equivalent scope thereof. Moreover, the components of different embodiments and modifications may be appropriately combined.

In addition, the effects of the embodiments described in the present specification are merely examples and are not limited, and other effects may be provided.

### Supplementary Notes

The present disclosure includes the following technique.

### Supplementary Note 1

A display device comprising:
a transmission reflection member configured to transmit part of incident light and reflect part of the incident light;
a display panel configured to display an image;
a sensor including a base material, a light emission element, and a light detection element, the base material having a first surface, the light emission element being located on the first surface, the light detection element being located on the first surface and receiving reflected light of light emitted by the light emission element;
an operating mechanism; and
a first control circuit configured to perform control to switch on and off of the display panel on the basis of an amount of light received by the light detection element, wherein the operating mechanism is configured to switch a relative position of the sensor with respect to the operating mechanism between a first position and a second position different from the first position, and change the amount of light received by the light detection element.

According to the supplementary note 1, the display device can be downsized as compared with a related art.

### Supplementary Note 2

The display device according to the supplementary note 1, wherein
the operating mechanism has multiple surfaces including a second surface,
the second surface is a surface facing the first surface when the relative position of the sensor with respect to the operating mechanism is the first position, and
an overlapping area between the first surface and the second surface when viewed in a normal direction of the first surface in a case where the relative position of the sensor with respect to the operating mechanism is the first position is larger than an overlapping area between the first surface and the second surface when viewed in the normal direction of the first surface in a case where the relative position of the sensor with respect to the operating mechanism is the second position.

According to the supplementary note 2, the amount of light received by the light detection element can be changed by changing the overlapping area of the operating mechanism and the sensor.

### Supplementary Note 3

The display device according to the supplementary note 1, wherein
the operating mechanism has multiple surfaces including a second surface,
the second surface is a surface facing the first surface when the relative position of the sensor with respect to the operating mechanism is at the first position, and
a shortest distance between the first surface and the second surface in a case where the relative position of the sensor with respect to the operating mechanism is the first position is shorter than a shortest distance between the first surface and the second surface in a case where the relative position of the sensor with respect to the operating mechanism is the second position.

According to the supplementary note 3, the amount of light received by the light detection element can be changed by changing the distance between the operating mechanism and the sensor.

### Supplementary Note 4

The display device according to any one of the supplementary notes 1 to 3, further comprising a first substrate located on a side opposite to the transmission reflection member with respect to the display panel, the first substrate having a third surface and a fourth surface opposed to each other, wherein
the display panel has a display surface displaying the image, and a fifth surface opposed to the display surface,
the third surface and the fifth surface face each other, and
the sensor is located on the fourth surface.

According to the supplementary note 4, the number of components of the display device can be reduced. Therefore, the weight of the display device can be reduced.

### Supplementary Note 5

The display device according to any one of the supplementary notes 1 to 3, further comprising:
a first substrate located on a side opposite to the transmission reflection member with respect to the display panel, the first substrate having a third surface; and
a second substrate having a sixth surface extending in a direction intersecting the display panel, wherein
the display panel has a display surface displaying the image, and a fifth surface opposed to the display surface,
the third surface and the fifth surface face each other, and
the sensor is located on the sixth surface.

According to the supplementary note 5, by making the relative position of the sensor with respect to the operating mechanism different, it is easy to make the amount of light received by the light detection element greatly different.

### Supplementary Note 6

The display device according to the supplementary note 4 or 5, further comprising a housing configured to support the transmission reflection member, the display panel, and the first substrate, wherein
the operating mechanism switches a position of the housing between a third position and a fourth position different from the third position, and
the relative position of the sensor with respect to the operating mechanism is the first position when the housing is at the third position, and the relative position of the sensor with respect to the operating mechanism is the second position when the housing is at the fourth position.

According to the supplementary note 6, it is possible to switch both the posture of the housing and on and off of the display panel only by operating the operating mechanism.

### Supplementary Note 7

The display device according to the supplementary note 6, wherein
the operating mechanism is located on the side opposite to the transmission reflection member with respect to the display panel, and
the operating mechanism includes
   a plate configured to support the housing, and
   a lever capable of switching a relative position of the housing with respect to the plate,
the plate includes a protruding part protruding in a direction from the display panel toward the transmission reflection member, and
the protruding part has the second surface.

According to the supplementary note 7, the operating mechanism includes the plate and the lever, and the protruding part having the second surface can be provided on the plate side. As a result, the degree of freedom in design is improved, and thus, for example, the second surface can be provided at a position closer to the sensor. Therefore, by making the relative position of the sensor with respect to the operating mechanism different, it is easy to make the amount of light received by the light detection element greatly different.

### Supplementary Note 8

The display device according to the supplementary note 6, wherein the operating mechanism is a lever located on the side opposite to the transmission reflection member with respect to the display panel.

According to the supplementary note 8, on and off of the display device can be switched with a simple configuration. Therefore, the weight of the display device can be reduced.

### Supplementary Note 9

The display device according to the supplementary note 8, wherein
the operating mechanism includes a protruding part protruding in a direction from the display panel toward the transmission reflection member, and
the protruding part has the second surface.

According to the supplementary note 9, on and off of the display device can be switched with a simple configuration. Therefore, the weight of the display device can be reduced.

### Supplementary Note 10

The display device according to the supplementary note 7, wherein the plate and the protruding part are formed of different materials.

According to the supplementary note 10, it is easy to set the reflectance of the second surface to a desired value.

### Supplementary Note 11

The display device according to the supplementary note 9, wherein the operating mechanism and the protruding part are formed of different materials.

According to the supplementary note 11, it is easy to set the reflectance of the second surface to a desired value.

### Supplementary Note 12

The display device according to the supplementary note 10 or 11, wherein the protruding part is formed of a reflective material.

According to the supplementary note 12, it is possible to obtain the second surface having a reflectance of a desired value by appropriately selecting the type of the reflective material and the manufacturing method.

### Supplementary Note 13

The display device according to the supplementary note 7 or 9, wherein a reflection sheet is attached to the second surface.

According to the supplementary note 13, it is possible to obtain the second surface having a reflectance of a desired value by appropriately selecting the type of the reflection sheet and the manufacturing method.

### Supplementary Note 14

The display device according to the supplementary note 7 or 9, wherein
the housing supports a panel operating mechanism for operating the display panel,
the panel operating mechanism supports the second substrate, and
the second substrate includes an LED configured to illuminate the panel operating mechanism.

According to the supplementary note 14, the sensor can be provided on the second substrate including the LED. Therefore, since the display device does not need to include an additional substrate for providing the sensor, the display device can be downsized.

### Supplementary Note 15

The display device according to any one of the supplementary notes 1 to 3, wherein the first control circuit is configured to cause the display panel to display the image when the relative position of the sensor with respect to the operating mechanism is the first position.

According to the supplementary note 15, when the relative position of the sensor with respect to the operating mechanism is the second position, no image is displayed on the display panel. Therefore, when the relative position of the sensor with respect to the operating mechanism is the second position, the display panel is hardly visually recognized by an occupant through the transmission reflection member.

### Supplementary Note 16

The display device according to any one of the supplementary notes 1 to 3, wherein the first control circuit is configured to cause the display panel to display the image when the relative position of the sensor with respect to the operating mechanism is the second position.

According to the supplementary note 16, when the relative position of the sensor with respect to the operating mechanism is the first position, no image is displayed on the display panel. Therefore, when the relative position of the sensor with respect to the operating mechanism is the first position, the display panel is hardly visually recognized by the occupant through the transmission reflection member.

### Supplementary Note 17

The display device according to any one of the supplementary notes 1 to 3, wherein the transmission reflection member includes
a transparent plate configured to transmit the incident light, and
a reflective polarizing layer located on a side of the display panel with respect to the transparent plate, the reflective polarizing layer transmitting light polarized in a first direction and reflecting light in a direction different from the first direction.

According to the supplementary note 17, a user can switch between a state of visually recognizing the image displayed on the display panel through the transmission reflection member and a state of visually recognizing a mirror image of light reflected by the transmission reflection member.

### Supplementary Note 18

The display device according to the supplementary note 17, wherein
the transmission reflection member further includes a first electrode, a second electrode, and a control substance located between the first electrode and the second electrode, and
a reflectance of the transmission reflection member changes in accordance with a state of the control substance varying with a potential difference between the first electrode and the second electrode.

According to the supplementary note 18, the reflectance of the transmission reflection member can be controlled in accordance with an environment around the vehicle.

What is claimed is:

1. A display device comprising:
a transmission reflection member configured to transmit part of incident light and reflect part of the incident light;
a display panel configured to display an image;
a sensor including a base material, a light emission element, and a light detection element, the base material having a first surface, the light emission element being located on the first surface, the light detection element being located on the first surface and receiving reflected light of light emitted by the light emission element;
an operating mechanism; and
a first control circuit configured to perform control to switch on and off of the display panel on the basis of an amount of light received by the light detection element,
wherein the operating mechanism is configured to
switch a relative position of the sensor with respect to the operating mechanism between a first position and a second position different from the first position, and
change the amount of light received by the light detection element.

2. The display device according to claim 1, wherein
the operating mechanism has multiple surfaces including a second surface,
the second surface is a surface facing the first surface when the relative position of the sensor with respect to the operating mechanism is the first position, and
an overlapping area between the first surface and the second surface when viewed in a normal direction of the first surface in a case where the relative position of the sensor with respect to the operating mechanism is the first position is larger than an overlapping area between the first surface and the second surface when viewed in the normal direction of the first surface in a case where the relative position of the sensor with respect to the operating mechanism is the second position.

3. The display device according to claim 1, wherein
the operating mechanism has multiple surfaces including a second surface,
the second surface is a surface facing the first surface when the relative position of the sensor with respect to the operating mechanism is at the first position, and
a shortest distance between the first surface and the second surface in a case where the relative position of the sensor with respect to the operating mechanism is the first position is shorter than a shortest distance between the first surface and the second surface in a case where the relative position of the sensor with respect to the operating mechanism is the second position.

4. The display device according to claim 1, further comprising a first substrate located on a side opposite to the transmission reflection member with respect to the display panel, the first substrate having a third surface and a fourth surface opposed to each other, wherein
the display panel has a display surface displaying the image, and a fifth surface opposed to the display surface,
the third surface and the fifth surface face each other, and
the sensor is located on the fourth surface.

5. The display device according to claim 2, further comprising:
a first substrate located on a side opposite to the transmission reflection member with respect to the display panel, the first substrate having a third surface; and
a second substrate having a sixth surface extending in a direction intersecting the display panel, wherein
the display panel has a display surface displaying the image, and a fifth surface opposed to the display surface,
the third surface and the fifth surface face each other, and
the sensor is located on the sixth surface.

6. The display device according to claim 5, further comprising a housing configured to support the transmission reflection member, the display panel, and the first substrate, wherein
the operating mechanism switches a position of the housing between a third position and a fourth position different from the third position, and
the relative position of the sensor with respect to the operating mechanism is the first position when the housing is at the third position, and the relative position of the sensor with respect to the operating mechanism is the second position when the housing is at the fourth position.

7. The display device according to claim 6, wherein
the operating mechanism is located on the side opposite to the transmission reflection member with respect to the display panel, and
the operating mechanism includes
a plate configured to support the housing, and
a lever capable of switching a relative position of the housing with respect to the plate,
the plate includes a protruding part protruding in a direction from the display panel toward the transmission reflection member, and
the protruding part has the second surface.

8. The display device according to claim 6, wherein the operating mechanism is a lever located on the side opposite to the transmission reflection member with respect to the display panel.

9. The display device according to claim 8, wherein
the operating mechanism includes a protruding part protruding in a direction from the display panel toward the transmission reflection member, and
the protruding part has the second surface.

10. The display device according to claim 7, wherein the plate and the protruding part are formed of different materials.

11. The display device according to claim 9, wherein the operating mechanism and the protruding part are formed of different materials.

12. The display device according to claim 10, wherein the protruding part is formed of a reflective material.

13. The display device according to claim 7, wherein a reflection sheet is attached to the second surface.

14. The display device according to claim 7, wherein
the housing supports a panel operating mechanism for operating the display panel,
the panel operating mechanism supports the second substrate, and
the second substrate includes an LED configured to illuminate the panel operating mechanism.

15. The display device according to claim 1, wherein the first control circuit is configured to cause the display panel to display the image when the relative position of the sensor with respect to the operating mechanism is the first position.

16. The display device according to claim 2, wherein the first control circuit is configured to cause the display panel to display the image when the relative position of the sensor with respect to the operating mechanism is the second position.

17. The display device according to claim 1, wherein the transmission reflection member includes
a transparent plate configured to transmit the incident light, and
a reflective polarizing layer located on a side of the display panel with respect to the transparent plate, the reflective polarizing layer transmitting light polarized in a first direction and reflecting light in a direction different from the first direction.

18. The display device according to claim 17, wherein
the transmission reflection member further includes a first electrode, a second electrode, and a control substance located between the first electrode and the second electrode, and
a reflectance of the transmission reflection member changes in accordance with a state of the control substance varying with a potential difference between the first electrode and the second electrode.
